(19) United States
(12) Patent Application Publication
(10) Pub. No.: US 2008/0268105 A1
(43) Pub. Date: Oct. 30, 2008

(54) Method of making stuffed marshmallows

(76) Inventor: Angela Seitz, Farmington, MN (US)

Correspondence Address: Gary L. Huusko, Suite 600, 7300 West 147th Street, Apple Valley, MN, 55124, US

(21) Appl. No.: 11/789,264

(22) Filed: Apr. 24, 2007

(51) Int. Cl. A23G 3/54

(52) U.S. Cl. 426/93; 426/103

(57) ABSTRACT

A method and process is disclosed for making stuffed marshmallows. Candy bars, or pieces thereof, are physically pressed into a marshmallow mixture a sufficient depth before the mixture becomes solid by using fingers or a similarly shaped utensil. Sufficient space between each piece of candy bar is required to make sure there is ample room to cut the marshmallow mixture when the mixture becomes solid. The sufficient depth and spacing of the candy bars ensures that each individual piece of stuffed marshmallow will have a piece of candy bar embedded therein, preventing leakage of the candy bar upon heating or roasting the stuffed marshmallow.

### FIELD OF THE INVENTION

This invention relates to a method of making stuffed marshmallows.

### BACKGROUND OF THE INVENTION

There is a long history of campers making a confectionary dessert called “s'mores” over the campfire using graham crackers, marshmallows and chocolate, whereby a marshmallow would be roasted to a temperature very near its melting point, at which time it would be placed between a “sandwich” of two graham crackers with a thin bar of chocolate. The heat from the marshmallow would, hopefully, melt the chocolate bar, in essence, fusing the “sandwich” together into a sticky, crunchy, melty confectionary concoction called a “s'more.”

The inherent problems with the making of s'mores included failure to get the marshmallow to a sufficiently high temperature to melt the chocolate bar, resulting in the chocolate bar being hard, rather than melted; having the chocolate bars prematurely melt in their wrapper; and uneven heating of the marshmallow, resulting in a partially melted chocolate bar. The resulting s'mores in each instance are not desirable for eating or enjoying.

The present invention solves those problems and results in a cleaner and more consistently made s'more.

A number of prior patents disclose alternative methods of stuffing candy and marshmallows with a variety of confections, including chocolate. The inherent problem with those methods, such as described in U.S. Pat. Nos. 6,800,312 (Biggs) and 4,120,627 (Abe), is that the filling can leak out of the marshmallow. The confectionary described by Abe in U.S. Pat. No. 4,120,627 also requires costly machinery, which relies only upon a pinching of the marshmallow to keep the filling from leaking out of the confection.

### SUMMARY OF THE INVENTION

According to the present invention, the method and process is started by making marshmallows from scratch in a pan. The pan of marshmallow mixture must remain warm and in a somewhat liquid state during the process, until allowed to cool before cutting the pieces. Candy bars, or pieces thereof, are physically pressed into the marshmallow mixture before the mixture becomes solid by using fingers or a similarly shaped utensil. Sufficient space between each piece of candy bar is required to make sure there is ample room to cut the marshmallows when the mixture becomes solid. Preferred candy bars would be chocolate, although any flavor or variety would be equally as pleasing. Other embodiments would show liquid chocolate, liquid chocolate candy bars or other liquid flavorings being injected into the marshmallow mixture before it sets by using a syringe, cake decorating tubes, or any other similar device. Again adequate space is given around each area where the filling is pressed or injected into the marshmallow mixture to allow room to cut the confection.

It is very important to do this step when the marshmallow mixture is still in a somewhat liquid state, the reason being, when the marshmallow mixture is still in a liquid type state it flows together and encases whatever filling is pressed or injected into it. Therefore, the process and resulting filled marshmallow keeps the filling from oozing out of the marshmallow while roasting it. When the mixture has become solid, the marshmallows are cut into squares, making sure to keep each pressed or injected filling in the middle of the cut piece, after which each cut piece is dusted with powdered sugar.

The stuffed marshmallows are then ready to eat raw or roast over a flame. When roasting the marshmallows, several different methods may be utilized, such as piercing the stuffed marshmallows with campfire roasting sticks and placing them over an open fire or grill, or using fondue sticks and roasting the marshmallow over a lit Sterno®-type or open flame.

### DESCRIPTION OF THE DRAWINGS

These and other claims of the present invention will be more fully understood by reading the following detailed description taken together with the drawings wherein:

FIG. 1 is a perspective cut-away view of a batch of marshmallow mixture with filling pressed into the mixture;

FIG. 2 is a similar view, but of the filling being injected into the marshmallow mixture.

FIG. 3 is a cut-away view of the stuffed marshmallow final product.

### DETAILED DESCRIPTION OF THE DRAWINGS

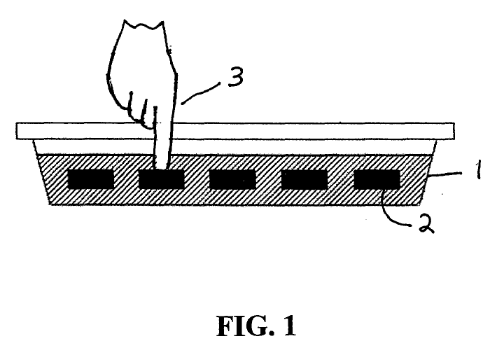

Referring first to FIG. 1, the preferred embodiment of the process is shown, having a liquid pan of marshmallow mixture 1, a piece of filling 2 being pressed into the mixture 1 by hand 3 whereby the piece of filling 2 is surrounded on all sides and enveloped by the mixture 1. The piece of filling 2 is also shown in the cut-away, being fully enveloped in the mixture 1. The filling 2 can also be pressed into the mixture 1 by any similar means, such as the end of a wooden spoon or the like. The filling 2 is pressed into the mixture 1 to a sufficient depth such that the filling 2 does not extend out of the bottom of the mixture 1, thereby becoming fully embedded and enveloped in the mixture 1. The filling 2 is shown imbedded into the mixture 1 at evenly spaced intervals, thereby allowing individual pieces of stuffed marshmallow to be cut so that the filling 2 will not leak out of the stuffed marshmallow.

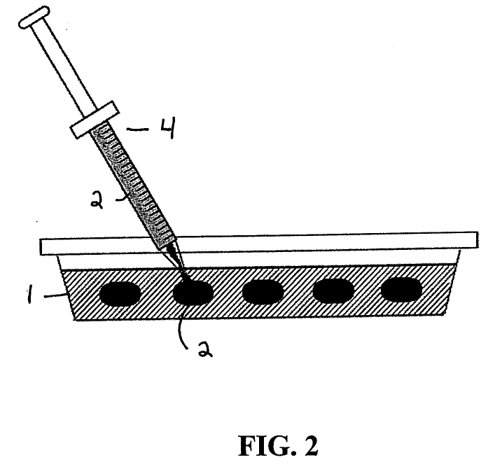

Referring now to FIG. 2, the filling 2 is now shown being injected into the mixture 1 by means of a syringe 4. Other similar utensils, such as a cake decorating tube, can be used as well.

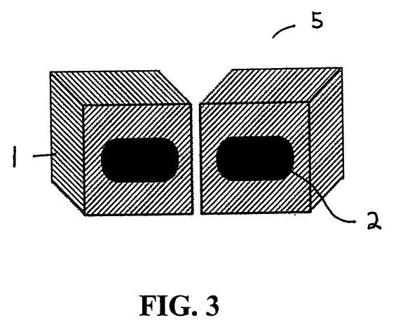

Referring to FIG. 3, the final stuffed marshmallow product 5 is shown after it is cut into individual pieces from the pan of marshmallow mixture 1 with the filling 2 embedded in and completely enveloped by the marshmallow mixture 1. The stuffed marshmallow 5 shows the filling 2 having marshmallow mixture 1 totally surrounding the filling 2.

While the preferred embodiment would have the filling 2 be a chocolate bar or piece of chocolate, any flavor or variety of candy or candy bar can be used, depending upon the taste preference of the consumer. Any type of candy that is capable of existing in a liquid state, such as melted chocolate candy bar or other melted candy bars, or flavored liquid can be injected into the mixture 1.

I claim:

1. A method of making a stuffed marshmallow comprising:
A mixture of marshmallow in a liquid state, a pan, and a filling, whereby the filling is pressed into the marshmallow mixture at evenly spaced intervals to a sufficient depth to allow the filling to be fully enveloped by the marshmallow mixture, the marshmallow mixture then being cut into individual pieces whereby each individual piece of marshmallow mixture has imbedded filling.

2. The method of claim 1 wherein the filling is comprised of a chocolate candy bar.

3. The method of claim 1 wherein the filling is comprised of a candy bar.

4. The method of claim 1 wherein the filling is candy.

5. A method of making a stuffed marshmallow comprising:
A mixture of marshmallow in a liquid state, a pan, an injection means, and a liquid filling, whereby the liquid filling is injected into the marshmallow mixture with the injection means at evenly spaced intervals to a sufficient depth to allow the liquid filling to be fully enveloped by the marshmallow mixture, the marshmallow mixture then being cut into individual pieces whereby each individual piece of marshmallow mixture has imbedded liquid filling.

6. The method of claim 5 wherein the liquid filling is comprised of a melted chocolate candy bar.

7. The method of claim 5 wherein the liquid filling is comprised of a melted candy bar.

8. The method of claim 5 wherein the liquid filling is comprised of a melted candy.

9. The method of claim 5 wherein the liquid filling is flavored.
